(19) United States
(12) Patent Application Publication
(10) Pub. No.: US 2016/0182699 A1
(43) Pub. Date: Jun. 23, 2016

(54) Multifunction Stylus

(71) Applicant: Robert F. Hou, Cupertino, CA (US)

(72) Inventor: Robert F. Hou, Cupertino, CA (US)

(21) Appl. No.: 14/578,321

(22) Filed: Dec. 19, 2014

(51) Int. Cl. H04M 1/21; G06F 3/0354; H04M 1/02

(52) U.S. Cl. CPC H04M 1/21; H04M 1/0202; G06F 3/03545

(57) ABSTRACT

This invention discloses a multifunction stylus that integrates the function of the conventional stylus and function of a mini phone handset together. The multifunction stylus can be used to assist in navigating, writing, and drawing when working with a touchscreen device. It can also be used as a mini phone handset for making and receiving phone calls via touchscreen devices. The multifunction stylus may include, among other components, a stylus tip, a microphone, a speaker, a wireless chipset, and a battery. It may also include an ear tip.

### THE FIELD OF INVENTION

This invention is related to a multifunction accessory for touchscreen devices. More specifically, it is related to a multifunction stylus for touchscreen devices that can be used as a stylus as well a mini phone handset for making and receiving phone calls.

### BACKGROUND OF INVENTION

Styluses have been used to assist in navigating, writing, or drawing when working with touchscreen devices such as smartphones or tablet computers. One of advantages of using a stylus instead of a finger is that it can be more precise. Another advantage is that it keeps the touchscreen clean. Many of touchscreen devices also use a microphone and a speaker for making and answering phone calls including internet phone calls. However, when the touchscreen is big, it becomes more difficult to make a private phone call using the devices directly at the ear level. A reasonable solution for this scenario is to use wired or wireless earphones such as earbuds or Bluetooth headsets, although it can be inconvenient to scramble in putting earphones into ears. US Patent Application 2013/051575 proposed a wireless headset with a touch pen. Functionally, the proposed headset allows a user to operate a touchscreen in addition to the wireless communication. However, because the proposed headset is essentially a headset, a user may still have to scramble in putting it into the ear. It can be difficult to optimize the design of the headset body so that it can be comfortably worn in users' ears while comfortably hold in users' hands for writing and drawing on touchscreens precisely. In addition, users may feel less stylish when using the headset in their hands to operate a touchscreen device.

Thus, there is a need for a cosmetically attractive multifunction accessory that can assist in navigating, writing, drawing, listening, or making phone calls when working with touchscreen devices.

### SUMMARY OF INVENTION

This invention discloses a multifunction stylus that integrates the function of the conventional stylus and function of a mini phone handset together. The multifunction stylus can be used to assist in navigating, writing, and drawing when working with a touchscreen device. It can also be used as a mini phone handset for making and receiving phone calls via touchscreen devices. In one of preferred embodiments, the multifunction stylus consists of a stylus tip for operating with a touchscreen device and a mini phone handset to be used as a handhold accessory of the touchscreen device for making and receiving phone calls. The said mini phone handset consists of a microphone for picking up a user's voice, an electric circuit for processing the microphone signal, communicating between a touchscreen device and the multifunction stylus, and for processing coded incoming voices from the touchscreen device, and a speaker for delivering the decoded incoming voices into users' ears. The multifunction stylus may further include a battery for supplying power to the microphone, the circuit, and the speaker. It may also include a button to be used, when pressed, to trigger a process for establishing a connection between the touchscreen device and the multifunction stylus.

### BRIEF DESCRIPTION OF DRAWINGS

Embodiments of the invention will be described in details with reference to figures.

FIG. 1a shows an exemplary appearance of the multifunction stylus according to one embodiment of the current invention.

FIG. 1b shows an exemplary appearance of the multifunction stylus with an ear tip according to one embodiment of the current invention.

FIG. 2 shows schematic connections of the electronic components which may be included in the multifunction stylus according to one embodiment of the current invention.

### DETAILED DESCRIPTIONS OF PREFERRED EMBODIMENTS

This invention is related to a multifunction accessory for touchscreen devices. More specifically, it is related to a multifunction stylus for touchscreen devices that can make and receive phone calls, including internet phone calls. The invention will be readily understood by the following detailed description in conjunction with the accompanying drawings which form part of specific embodiments.

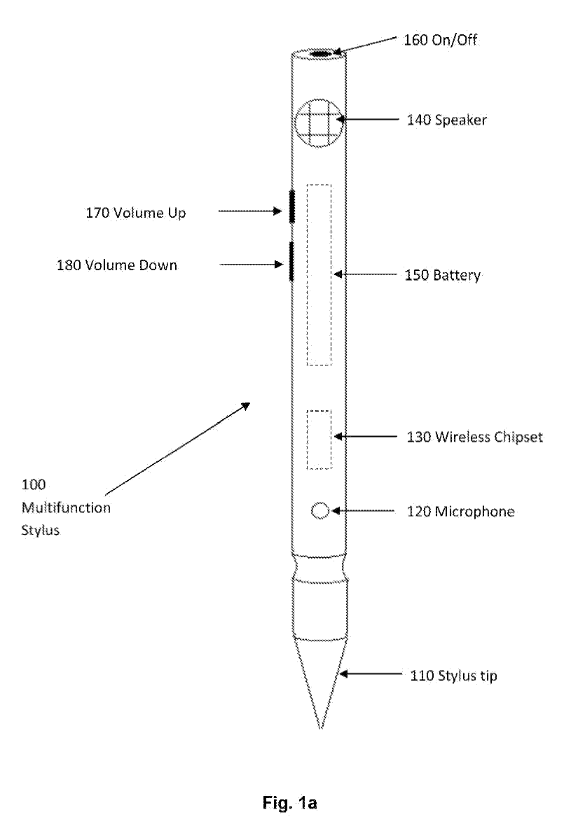

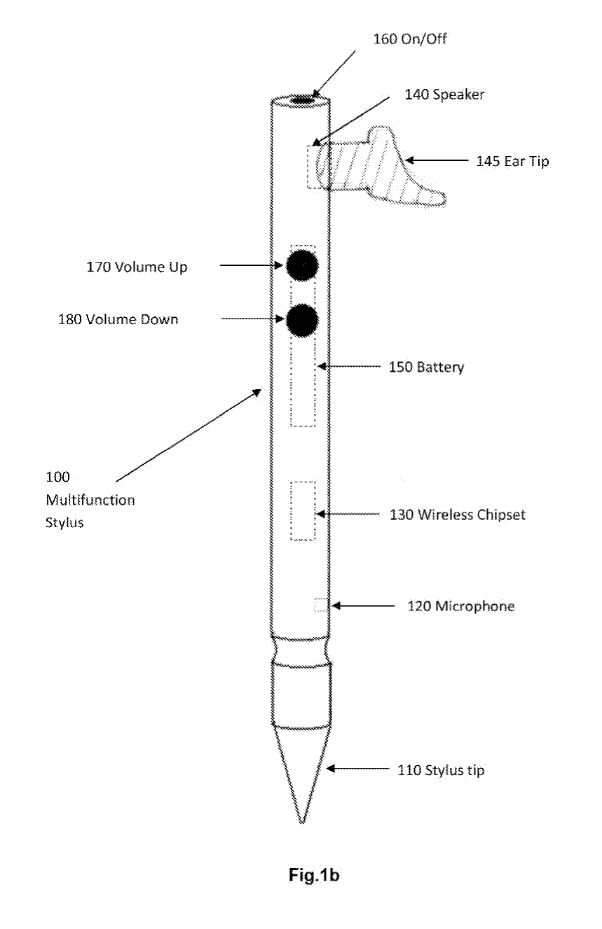

With reference to FIG. 1a, the Multifunction Stylus 100 is invented to perform at least two distinct functions, one as a conventional stylus, and other as a wireless phone handset which is similar to a wireless headset such as a Bluetooth headset except that it does not have to be on users' ears. The multifunction stylus includes a Stylus Tip 110 that can be used to perform the function of a conventional stylus, such as navigating, writing, or drawing when working with a touchscreen device. The multifunction stylus also includes a wireless handset. The handset may include electrical components such as Microphone 120, a Wireless Chipset 130, a Speaker 140, and a Battery 150. Typically, a handset is different from a headset in its length and design. A handset is designed to be used with the device in a user's hand, while headset is designed to be used with the device in a user's ear or on user's head. A handset is longer with the microphone and receiver separated by at least 8 cm. The advantage of the greater separation is that the microphone can be closer to user's mouth when the handset is in use. Normally, as the microphone gets closer to the mouth, the SNR (signal to noise ratio) of the voice picked up by the microphone becomes better.

The handset may also include an On/Off button 160, a Volume Up button 170, and a Volume Down button 180, to be used by a user to control the handset features such as turning the handset on/off, increasing or decreasing the speaker volume, etc. Typically, when making or receiving a phone call, a user presses the On/Off button 160 to turn on the handset function and connecting it wirelessly to user's smartphone. The user's voice signal is picked by Microphone 120, processed and coded by the Wireless Chipset 130 and wirelessly transmitted to the smartphone. The smartphone, in turn, sends the coded voice signal to the other end of the call. On the other hand, after the smartphone receives and processes the incoming signal from other end of the call, it codes and transmits the incoming signal wirelessly to the Wireless Chipset 130, which further processes and decodes the signal and presents it to the Speaker 140. During the call, the user can adjust the speaker volume by Volume Up 170 or Volume Down 180. The Microphone 120, Speaker 140, Wireless Chipset 130, On/Off button 160, Volume Up button 170, and Volume Down button 180, are all powered by a Battery 150. The Battery 150 can be either rechargeable or non-rechargeable. If it is rechargeable, the multifunction stylus shall include an interface mechanism for the rechargeable battery to be charged. The interface mechanism of a rechargeable battery is well known in the art and is beyond the scope of the current invention.

When using the Multifunction Stylus 100 as a phone handset, the Speaker 140 is put in the proximity of the entrance of a user's ear canal. An ear tip can used to increase the coupling efficiency of acoustic signal from the speaker to the ear canal. With reference to FIG. 1b, the multifunction stylus further includes a mechanism for installing an Ear Tip 145, designed to efficiently couple the acoustic signal from the Speaker 140 to the user's ear canal. As one embodiment, the mechanism can be a small protruding tube extended from the Speaker 140. As another embodiment, the mechanism can be a small protruding tube extended from the main body of the Multifunction Stylus 100 with the Speaker 140 mounted at the end of the tube. The Ear Tip 145 can simply be snapped onto the protruding tube. Yet as another embodiment, the mechanism includes the holding loop on the ear tip, whereas the holding loop is used to hold the ear tip over the speaker outlet so that acoustic signal from the speaker is efficiently coupled into the user's ear via the ear tip. The Ear Tip 145 can be designed to have a shape roughly following the anatomy of the cavity near the entrance of the human ear canal, including the ear concha and the external auditory meatus, so that it can be put into users' ears easily and retained firmly. Ideally, the Ear Tip 145 can be custom-made for each individual user. In practice, however, it may be more feasible to supply standard ear tips with a few different sizes for a user to select from. Usually, 3 to 4 sizes will cover majority of population.

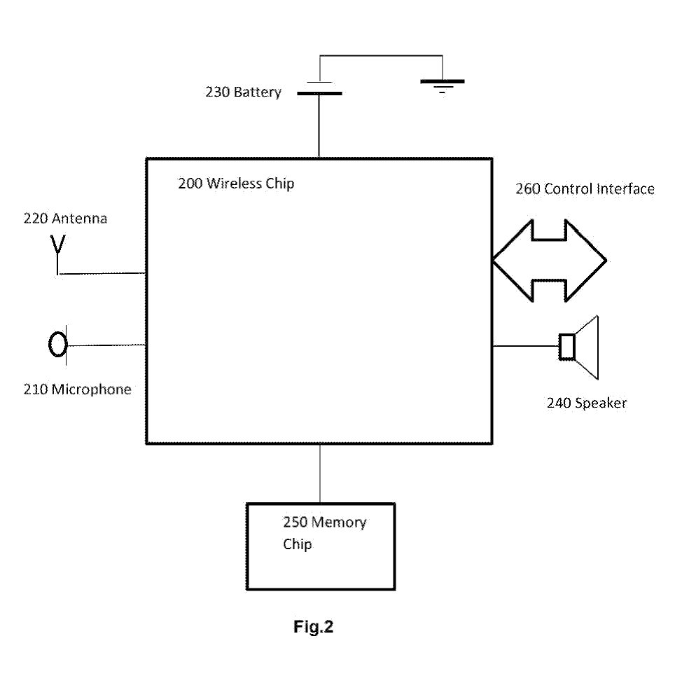

The wire connections of the electrical components in FIGS. 1a and 1b that make the multifunction stylus function as a wireless mini phone handset is similar to the conventional wireless earphone, and are illustrated in FIG. 2. With reference to FIG. 2, the Microphone 210 picks up the user's voice signal and converts it into the electrical signal. The electrical output of the microphone is fed into a Wireless Chip 200. There are multiple off-the-shelf wireless chips designed for wireless earphones. For example, CSR8670 is a wireless Bluetooth chip designed for use in the Bluetooth headset and can be implemented as the Wireless Chip 200. The Wireless Chip 200 processes and codes the microphone output and sends it wirelessly to a smartphone via a RF (radio frequency) Antenna 220. One the other hand, the coded voice signal from other end of the call is received, processed, and transmitted by the smartphone. The transmitted incoming signal is received by the Antenna 220, fed into the Wireless Chip 200, processed, decoded, and delivered to the Speaker 240 as the incoming voice signal. The Wireless Chip 200 is also connected to a user Control Interface 260 such as an on/off button or volume control buttons. Volume buttons can be either a mechanical button or a sweep button with electrical leads. The Wireless Chip 200 can be optionally connected to an external Memory Chip 250 for data storage. The Wireless Chip 200, the external Memory Chip 250, and the Antenna 220 can be packed into a single module corresponding to the Wireless Chipset 130 of FIG. 1. Electrical components 200, 210, 220, 240, 250, and 260 are all powered by a Battery 230.

The advantage of the current invention is that the multifunction stylus has at least two distinct functions. It can be used as a conventional stylus operating to assist in navigating, writing, and drawing when working with a touchscreen device such as a smartphone. It can also be used a wireless mini phone handset accessory working with a touchscreen device such as a smartphone when making or answering a call. The combination of the two functions makes it more convenient to work with a large sized touchscreen device. The stylus function makes it possible to operate the touchscreen device with more precision while keeping the touchscreen clean. The wireless mini phone handset function makes it possible to do a private phone call using a large touchscreen device without having to put the large touchscreen close to user's ear. Because both functions are performed with the accessory in users' hands, the design of the accessory body can be easily made to optimize both usability and cosmetics.

What is claimed are:

1. A multifunction accessory for a touchscreen device, the said accessory can be used as:
a stylus for navigating, writing, or drawing on the touchscreen device; and
a mini phone handset working with the touchscreen device for making and answering phone calls.

2. A multifunction accessory in claim 1, where the mini phone handset is a wireless mini phone handset.

3. A multifunction accessory in claim 2, where the wireless phone handset is a Bluetooth phone handset.

4. A multifunction accessory in claim 1, where the touchscreen device is a smartphone.

5. A multifunction accessory in claim 1, where the touchscreen device is a tablet computer.

6. A multifunction accessory for a touchscreen device includes at least:
a stylus tip for navigating, writing, or drawing on the touchscreen device;
a mini phone handset working with a touchscreen device for making and answering phone calls.

7. A multifunction accessory in claim 6, where the mini phone handset at least consists of:
a. a microphone for picking up a user's voice;
b. a speaker for reproducing incoming voices;
c. a chipset for processing the user's voice signal and transmitting the processed signal to the touchscreen device, and for receiving, processing, decoding, and reproducing the incoming voice signals from the touchscreen device;
d. a battery for powering the said microphone, speaker, and the chipset.

8. A multifunction accessory in claim 7, where the chipset includes a wireless chip.

9. A multifunction accessory in claim 8, where the chipset further includes a RF antenna.

10. A multifunction accessory in claim 8, where the chipset further includes an external memory chip.

11. A multifunction accessory in claim 8, where the wireless chip is a Bluetooth chip.

12. A multifunction accessory in claim 7, where the mini phone handset further includes a button for the user to turn the mini phone handset on or off.

13. A multifunction accessory in claim 7, where the mini phone handset further includes mechanism for increasing or decreasing the volume of the speaker.

14. A multifunction accessory in claim 6, where the mini phone handset further includes a mechanism for installing an ear tip for coupling the speaker's output into the user's ear.

15. A multifunction accessory in claim 14, where the mechanism is a small protruding tube extended from the main body of the multi-function accessory.

16. A multifunction accessory in claim 14, where the mechanism is a holding loop on the ear tip to hold the ear tip over the speaker.

17. A multifunction accessory in claim 6, where the touchscreen device is a smartphone.

18. A multifunction accessory in claim 6, where the touchscreen device is a tablet computer.
